(19) United States
(12) Patent Application Publication
(10) Pub. No.: US 2013/0147679 A1
(43) Pub. Date: Jun. 13, 2013

(54) ANTENNA STRUCTURE OF HANDHELD DEVICE

(71) Applicant: Chang-Yueh JENG, Taipei Hsien (TW)

(72) Inventor: Chang-Yueh JENG, Taipei Hsien (TW)

(73) Assignee: Acer Incorporated, Taipei Hsien (TW)

(21) Appl. No.: 13/454,981

(22) Filed: Apr. 24, 2012

(30) Foreign Application Priority Data
Dec. 8, 2011 (TW) 100145293

(51) Int. Cl. H01Q 1/50

(52) U.S. Cl. 343/860

(57) ABSTRACT

An antenna structure includes a matching circuit, a flexible printed circuit board, and an external metal element. The matching circuit is configured to provide impedance. The flexible printed circuit board has a variable shape, wherein a metal wire is disposed on the flexible printed circuit board. The external metal element is coupled to a signal source through the metal wire disposed on the flexible printed circuit board and the matching circuit.

### CROSS REFERENCE TO RELATED APPLICATIONS

This Application claims priority of Taiwan Patent Application No. 100145293 filed on Dec. 8, 2011, the entirety of which is incorporated by reference herein.

### BACKGROUND OF THE INVENTION

1. Field of the Invention

The disclosure generally relates to an antenna structure, and more particularly, relates to an antenna structure disposed on a handheld device.

2. Description of the Related Art

With the progress of mobile communication technology, portable electronic devices, for example, portable computers, mobile phones, multimedia players, and other hybrid functional portable electronic devices, have become more common. To satisfy the demand of users, portable electronic devices usually can perform wireless communication functions. Some functions cover a large wireless communication area, for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area, for example, mobile phones using Wi-Fi, Bluetooth, and WiMAX (Worldwide Interoperability for Microwave Access) systems and using frequency bands of 3.5G Hz, 5.2G Hz, and 5.8G Hz.

Traditionally, a metal element with a fixed size is used as a main body of an antenna. The metal element is one-second wavelength or one-fourth wavelength in length, wherein the wavelength corresponds to the desired frequency band. Traditional designs limit the sizes and shapes of the metal element so that it is difficult to design appearances of the antennas. Moreover, the metal element with a fixed size limits radiation patterns of antennas.

### BRIEF SUMMARY OF THE INVENTION

To solve the foregoing problem, the invention provides an antenna structure that uses an external metal element of a handheld device (e.g., a mobile phone or a tablet PC) as a part of the antenna structure. The antenna structure may further comprise a flexible printed circuit board (FPCB) having a variable shape and a matching circuit so as to increase flexibility in designing the antenna structure and reduce the space occupied by the antenna structure.

In one exemplary embodiment, the disclosure is directed to an antenna structure, comprising: a matching circuit, arranged for providing impedance; a flexible printed circuit board (FPCB), having a variable shape, wherein a metal wire is disposed on the FPCB; and an external metal element, coupled to a signal source through the metal wire disposed on the FPCB and the matching circuit.

In another embodiment, the disclosure is directed to a handheld device, comprising: a case; and an antenna structure, comprising: a matching circuit, arranged for providing impedance; a flexible printed circuit board (FPCB), having a variable shape, wherein a metal wire is disposed on the FPCB; and an external metal element, disposed on the case, and coupled to a signal source through the metal wire disposed on the FPCB and the matching circuit.

### BRIEF DESCRIPTION OF DRAWINGS

The invention can be more fully understood by reading the subsequent detailed description and examples with references made to the accompanying drawings, wherein:

FIG. 1 is a diagram for illustrating an antenna structure according to an embodiment of the invention;

FIG. 2 is a diagram for illustrating an antenna structure according to a preferred embodiment of the invention;

FIG. 3A is a sectional drawing for illustrating the antenna structure disposed on a mobile phone according to an embodiment of the invention;

FIG. 3B is a pictorial drawing for illustrating the antenna structure disposed on the mobile phone according to an embodiment of the invention;

FIG. 4 is a diagram for illustrating return loss over frequency of the antenna structure according to an embodiment of the invention; and

FIG. 5 is a diagram for illustrating return loss over frequency of the antenna structure according to another embodiment of the invention.

### DETAILED DESCRIPTION OF THE INVENTION

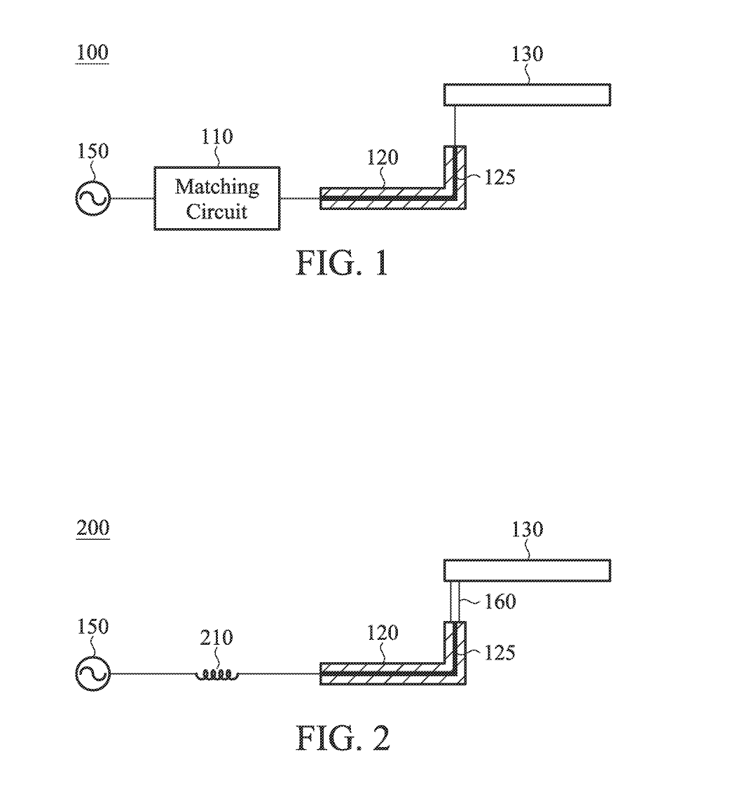

FIG. 1 is a diagram for illustrating an antenna structure 100 according to an embodiment of the invention. As shown in FIG. 1, the antenna structure 100 comprises: a matching circuit 110, a flexible printed circuit board (FPCB) 120, an external metal element 130, and a signal source 150. In another embodiment, the signal source 150 may be disposed outside of the antenna structure 100 and provide energy or signals so as to feed the antenna structure 100. The matching circuit 110 may comprise one or more inductors and/or capacitors so as to provide appropriate impedance. The FPCB 120 has a variable shape. For example, the FPCB 120 may have a straight shape or an irregular shape, or even be folded so as to have a three-dimensional shape. There are at least one metal wire 125 disposed on the FPCB 120, wherein the metal wire 125 substantially has the same length as that of the FPCB 120. The external metal element 130 may be disposed on a case of a handheld device (e.g., a mobile phone, a tablet PC, or a notebook), and electrically coupled to the signal source 150 through the metal wire 125 disposed on the FPCB 120 and the matching circuit 110. It is noted that in FIG. 1, the matching circuit 110 may be interchanged with the FPCB 120; that is, a different order of the matching circuit 110 and the FPCB 120 is allowable.

FIG. 2 is a diagram for illustrating an antenna structure 200 according to a preferred embodiment of the invention. As shown in FIG. 2, the antenna structure 200 comprises: a coil inductor 210, a flexible printed circuit board (FPCB) 120, an external metal element 130, a connection element 160, and a signal source 150. The antenna structure 200 is similar to the antenna structure 100 as shown in FIG. 1. The only difference between them is that the matching circuit 110 is replaced with the coil inductor 210, and the external metal element 130 is electrically coupled to the metal wire 125 disposed on the FPCB 120 further through the connection element 160. The coil inductor 210 is configured to provide an appropriate inductance for the antenna structure 200 and effectively reduce total length of the antenna structure 200. In a preferred embodiment of the invention, the inductance of the coil inductor 210 is approximately equal to 12 nH. The connection element 160 may be a flexible metal piece or a pogo pin. It is noted that a designer can change the length of the FPCB 120 and the inductance of the coil inductor 210 according to desired frequency bands of the antenna structure.

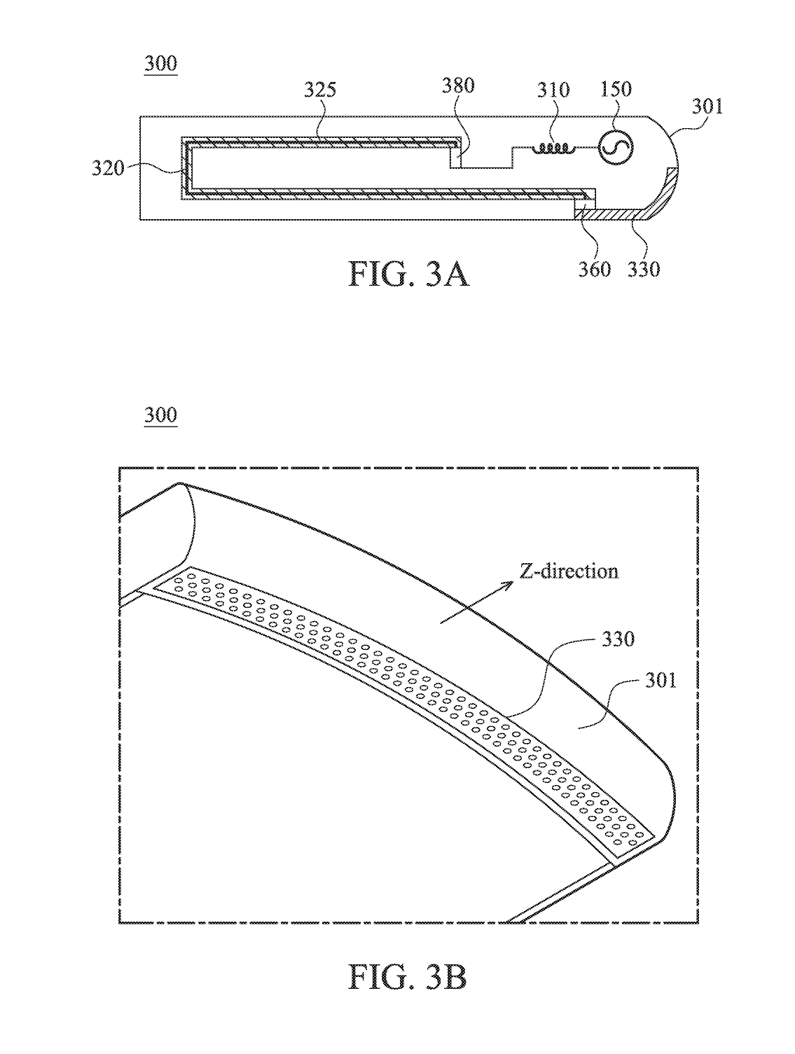

FIG. 3A is a sectional drawing for illustrating the antenna structure disposed on a mobile phone 300 according to an embodiment of the invention. As shown in FIG. 3A, am external metal element 330 is disposed on a case 301 of the mobile phone 300. The external metal element 330 may have a straight shape, a round shape, or an irregular shape. A coil inductor 310 is electrically coupled to a signal source 150, and electrically coupled to a metal wire 325 disposed on a flexible printed circuit board (FPCB) 320 through a connection element 380. The external metal element 330 is electrically coupled to the metal wire 325 disposed on the FPCB 320 through another connection element 360. Similarly, the connection elements 360 and 380 may be flexible metal pieces or pogo pins. In the embodiment, a monopole antenna structure is formed by the coil inductor 310, the connection element 380, the metal wire 325 disposed on the FPCB 320, the connection element 360, and the external metal element 330. In other embodiments, the connection elements 360 and 380 may be removed from the monopole antenna structure. With the coil inductor 310 and the FPCB 320 that can be bent, the monopole antenna structure occupies a small space. A designer can dispose the monopole antenna on a handheld device easily.

FIG. 3B is a pictorial drawing for illustrating the antenna structure disposed on the mobile phone 300 according to an embodiment of the invention. As shown in FIG. 3B, the external metal element 330 is disposed on the case 301 of the mobile phone 300. When a user operates the mobile phone 300, the external metal element 330 is substantially perpendicular to Z-direction, which is oriented toward the sky. Therefore, the antenna structure has enough antenna gain in the Z-direction.

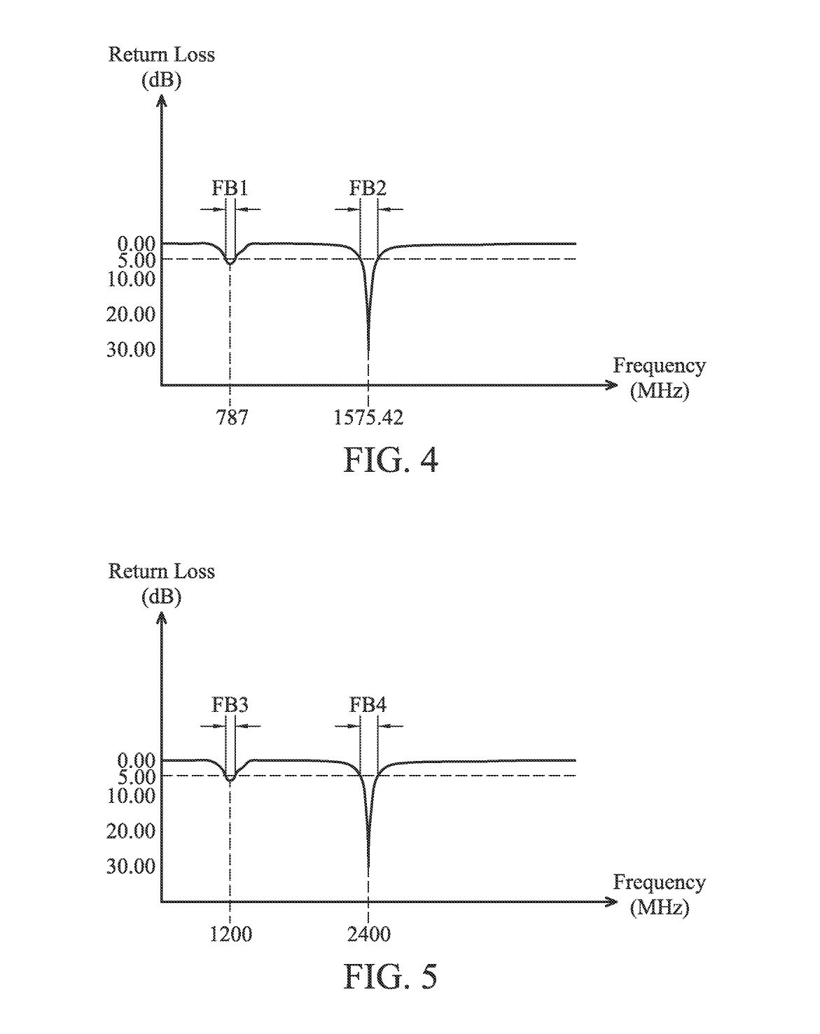

FIG. 4 is a diagram for illustrating return loss over frequency of the antenna structure according to an embodiment of the invention. As shown in FIG. 4, the vertical axis represents return loss (unit: dB), and the horizontal axis represents operating frequency (unit: MHz). When a signal is fed into the antenna structure, the matching circuit 110 (or the coil inductor 210), the metal wire 125 disposed on the FPCB 120, and the external metal element 130 are excited so as to form at least frequency bands FB1 and FB2. In a preferred embodiment, the frequency band FB1 is approximately from 737 MHz to 837 MHz, and the frequency band FB2 is approximately from 1525 MHz to 1625 MHz. The frequency band FB1 is formed by a fundamental oscillation mode of the antenna structure, and the frequency band FB2 is formed by a second oscillation mode of the antenna structure. It is noted that the antenna structure of the invention covers the GPS (Global Positioning System) band by the second oscillation mode, not the fundamental oscillation mode. In a preferred embodiment, the external metal element 130 is approximately 50 mm in length, and the FPCB 120 and the metal wire 125 are both approximately 80 mm in length. Similarly, a designer can change the length of the FPCB 120 and the length of external metal element 130 according to desired frequency bands.

FIG. 5 is a diagram for illustrating return loss over frequency of the antenna structure according to another embodiment of the invention. As shown in FIG. 5, the vertical axis represents return loss (unit: dB), and the horizontal axis represents operating frequency (unit: MHz). When a signal is fed into the antenna structure, the matching circuit 110 (or the coil inductor 210), the metal wire 125 disposed on the FPCB 120, and the external metal element 130 are excited so as to form at least frequency bands FB3 and FB4. In a preferred embodiment, the frequency band FB3 is approximately from 1150 MHz to 1250 MHz, and the frequency band FB4 is approximately from 2350 MHz to 2450 MHz. The frequency band FB3 is formed by a fundamental oscillation mode of the antenna structure, and the frequency band FB4 is formed by a second oscillation mode of the antenna structure.

Each of the antenna structures of the invention comprises an external metal element. By adjusting the length of an FPCB and impedance of a matching circuit, the antenna structure can easily cover desired frequency bands.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. An antenna structure, comprising:
a matching circuit, arranged for providing impedance;
a flexible printed circuit board (FPCB), having a variable shape, wherein a metal wire is disposed on the FPCB; and
an external metal element, coupled to a signal source through the metal wire disposed on the FPCB and the matching circuit.

2. The antenna structure as claimed in claim 1, wherein the matching circuit is a coil inductor.

3. The antenna structure as claimed in claim 1, further comprising:
a connection element coupled between the metal wire disposed on the FPCB and the matching circuit, wherein the external metal element is coupled to the signal source through the metal wire disposed on the FPCB, the connection element, and the matching circuit.

4. The antenna structure as claimed in claim 1, wherein the external metal element is disposed on a case of a handheld device.

5. The antenna structure as claimed in claim 1, wherein the matching circuit, the metal wire disposed on the FPCB, and the external metal element are excited to form a first frequency band and a second frequency band.

6. The antenna structure as claimed in claim 5, wherein the first frequency band is approximately from 737 MHz to 837 MHz, and the second frequency band is approximately from 1525 MHz to 1625 MHz.

7. The antenna structure as claimed in claim 5, wherein the first frequency band is approximately from 1150 MHz to 1250 MHz, and the second frequency band is approximately from 2350 MHz to 2450 MHz.

8. A handheld device, comprising:
a case; and
an antenna structure, comprising:
a matching circuit, arranged for providing impedance;
a flexible printed circuit board (FPCB), having a variable shape, wherein a metal wire is disposed on the FPCB; and
an external metal element, disposed on the case, and coupled to a signal source through the metal wire disposed on the FPCB and the matching circuit.

9. The handheld device as claimed in claim 8, wherein the matching circuit is a coil inductor.

10. The handheld device as claimed in claim 8, further comprising:
a connection element coupled between the metal wire disposed on the FPCB and the matching circuit, wherein the external metal element is coupled to the signal source through the metal wire disposed on the FPCB, the connection element, and the matching circuit.

11. The handheld device as claimed in claim 8, wherein the matching circuit, the metal wire disposed on the FPCB, and the external metal element are excited to form a first frequency band and a second frequency band.
